(19) United States
(12) Patent Application Publication
(10) Pub. No.: US 2006/0293984 A1
(43) Pub. Date: Dec. 28, 2006

(54) Rollover solutions

(75) Inventors: Tom Loch, Holgate, NJ (US); Wilker Shane Bruce, Boca Raton, FL (US); Michael Marr, Chicago, IL (US)

Correspondence Address: FOX ROTHSCHILD LLP, 100 PARK AVENUE, SUITE 1500, NEW YORK, NY, 10017, US

(73) Assignee: Wealth Management Systems, Inc., Holgate, NJ (US)

(21) Appl. No.: 11/167,812

(22) Filed: Jun. 27, 2005

(51) Int. Cl. G06Q 40/00

(52) U.S. Cl. 705/35

(57) ABSTRACT

An apparatus for and a method of an electronic middleware interface consisting of communication interfaces designed to transfer data between financial record keeping systems and new account opening applications is presented. A retirement savings plan (RSP) administrator computer server communicates via the electronic middleware communication interfaces to a Rollover Solutions Network (RSN) application computer server to communicate financial savings plan participant data. The RSN application computer server utilizes the participant data to contact a financial service provider (FSP) computer server to identify the participant retirement accounts for rollover purposes. Alternatively, the RSN application computer server can contact the FSP computer server to open a new retirement account. Utilizing either the established retirement account or the new retirement account the RSN application computer server instructs the RSP administrator computer server to initiate rollover of the participants retirement account funds to the FSP.

### BACKGROUND OF THE INVENTION

1. Field of the Invention

The present invention relates to a method and apparatus for facilitating seamless financial transfers between savings plan administrators and financial service providers on behalf of retirement account participants, and more particularly, to a method and apparatus for provision of an electronic middleware interface between record keeping systems and new account opening applications to facilitate account openings and automate distribution processes.

2. Description of the Prior Art

To increase personal savings and to ensure adequate availability of retirement funds for individuals approaching retirement age, the government enacted a number of programs to assist workers in putting money aside. These retirement programs have taken the form of individual retirement accounts (e.g., IRAs and 401K accounts). However, as the average American will work for 11 different companies over the span of his or her lifetime, the issues of portability, ease of access and accountability have arisen. In addition, studies have shown that by 2010 over 2.4 trillion dollars are expected to flow into these retirement accounts. Thus, as participants continue to save for retirement, change jobs and age, issues of portability, savings and investment consolidation will continue to be of a concern.

It is estimated that 32% of Americans saving for retirement intend to rollover their 401K assets upon a change of job into an IRA. For retirement account administrators there are continuing challenges to enhance the record keeping systems and to leverage the latest technology to improve client service offerings. Indeed in today's competitive environment, there is significant pressure to: increase transaction volume; enhance service level technology; reduce operating costs; and increase revenue. For the financial service providers, it is clear the competition to retain and attract assets is increasing as Americans roll their retirement savings into IRA accounts in record numbers. In today's increasingly competitive market place, financial service providers are challenged to: enhance asset retention efforts, attract a larger percentage of rollovers within the market place; automate and simplify rollover processes for investors; and define a rollover servicing strategy to target communications, IRA products and services to desirable investors.

Thus there is a need for a system and method that can ensure both speed and accuracy for financial rollover transactions and that can automate the process of communications between the retirement account administrators and the financial service providers.

### SUMMARY OF THE INVENTION

Accordingly, the present invention is directed to a computer server middleware application that would facilitate the exchange of retirement savings account participant data across multiple record keeping platforms and retirement account opening systems. The system and method of the present invention electronically processes participant distribution and facilitates real time account openings by routing participant account data from retirement savings plan administrators to financial service provider account opening systems.

The middleware application is launched from within the existing retirement savings plan administrator web site, via a navigation link, or directly from the rollover system network computer server. When the navigation link is clicked, the retirement savings plan administrator server retrieves information about the participant and his/her account from its database, formats that information into an XML document, and submits select information to the middleware application server through a “Web Site Integration” server-to-server communication interface.

Integration to the retirement savings plan administrator web session and record-keeping system having been established, the middleware application server is able to gather and store participant indicative data, current participant account balance, and retirement savings plan administrator identification data via a “Participant Indicative Data” server-to-server communication interface. The participant data is stored within the middleware application's unique session and used to launch the initial distribution choices web page.

Once the participant selects to rollover his/her existing 401(k) balance into a particular IRA Rollover account, the middleware application controls the page flow. The middleware application first asks the participant for permission to transmit their data to the financial service provider server and search for existing accounts on the financial service provider server database. If the participant grants the middleware application server permission to transmit data and search for existing accounts, the middleware application server calls the “Existing Accounts” server-to-server communication interface on the financial service provider server. The “Existing Accounts” server-to-server communication interface returns to the middleware application server with any existing accounts and the participant is presented a list of current accounts. The participant is always provided the option to open a new account on the selection page and if no accounts are found, then opening a new account is the only option.

If participant denies permission to access existing account, then they are directed to the new account opening interface with pre-populated data. If a participant denies permission to transmit data, then they are directed to the new account opening interface without pre-populated data.

Once a participant selects to open a new account, the middleware application server connects to the financial server provider server account opening system, transfers the gathered participant indicative data to the system, and allows the financial server provider server account opening system to control the page flow.

Upon successful completion of the account opening process, the financial server provider server transfers control of the page flow back to the middleware application, generates a new account number, connects to the middleware application server via the “New Account Return” server-to-server communication interface, and transmits the new account number to the middleware application server.

The middleware application, upon receiving control of the page flow, directs the participant to the confirmation of distribution web page that requires the participant to review and confirm the transfer of money from the retirement savings plan administrator to the financial server provider. Upon confirmation the participant is directed to a thank you web page and the transaction request is completed.

On the server, the middleware application tracks the participant through the process and once the middleware application server has received the destination IRA account number from the financial server provider server and the participant confirmation to distribute funds, the transaction is flagged for upload. The middleware application server connects to the retirement savings plan administrator via the “Create Distribution Request” server-to-server communication interface and transmits distribution requests for any account that has been flagged. The timing of this connection is configurable and set based on the timing rules currently in place at the retirement savings plan administrator.

The middleware application server tracks the status of previously requested transactions on the retirement savings plan administrator record-keeping system through the “Distribution Transaction Status” server-to-server communication interface. This server-to-server communication interface is used by the middleware application server to query the retirement savings plan administrator system as to the current status of the requested transaction. The timing of this query is configurable but will run at lease once a day.

Once the middleware application server receives notification from the retirement savings plan administrator that the distribution has been processed, the transaction is flagged as completed with in the middleware application server database. The middleware application server generates a bill for each financial service provider on the system monthly with detailed information about each transaction marked as completed.

The present invention, including its features and advantages, will become more apparent from the following detailed description with reference to the accompanying drawings.

### BRIEF DESCRIPTION OF THE DRAWINGS

FIG. 1 illustrates a block diagram for an electronic data exchange and record keeping system for providing rollover of financial retirement funds, according to an embodiment of the present invention.

FIG. 2 illustrates a flow chart of the steps of a method for initiation of rollover or distribution of financial retirement funds between a participant and a retirement savings plan administrator, according to an embodiment of the present invention.

FIG. 3 illustrates a flow chart of the steps of a method for the presentation and selection of roll over of financial retirement funds, according to an embodiment of the present invention.

FIG. 4 illustrates a flow chart of the steps of a method for contact between the Rollover Solutions Network (RSN) application server and a financial service provider (FSP) server for identification and presentation of eligible accounts for roll over of financial retirement funds to the participant, according to an embodiment of the present invention.

FIG. 5 illustrates a flow chart of the steps of a method for identification and selection of an account for rollover of financial retirement funds, according to an embodiment of the present invention.

FIG. 6 illustrates a flow chart of the steps of a method for promotion of the rollover/distribution of financial retirement funds and confirmation of the financial transaction, according to an embodiment of the present invention.

FIG. 7 illustrates a diagram of web page for an introductory account summary and distribution link for a financial retirement account plan participant, according to an embodiment of the present invention.

FIG. 8 illustrates a diagram of a web page for a rollover selection, according to an embodiment of the present invention.

FIG. 9 illustrates a diagram of a web page for a rollover destination “market place”, according to an embodiment of the present invention.

FIG. 10 illustrates a diagram of a web page for a comparison worksheet, according to an embodiment of the present invention.

FIG. 11 illustrates a diagram of a web page for a profile example of a financial services provider, according to an embodiment of the present invention.

FIG. 12 illustrates a diagram of a web page for a permissions page, according to an embodiment of the present invention.

FIG. 13 illustrates a diagram of a web page for a confirmation screen, according to an embodiment of the present invention.

FIG. 14 illustrates a diagram of a web page for an account opening data sheet, according to an embodiment of the present invention.

FIG. 15 illustrates a diagram of a web page for a withdrawal confirmation, according to an embodiment of the present invention.

FIG. 16 illustrates a data table for input and output data required for a server-to-server communication and authentication interface, according to an embodiment of the present invention.

FIGS. 17A and 17B illustrate tables for input data and output data, respectively, for data flow between the Retirement Savings Plan (RSP) & RSN computer servers, according to an embodiment of the present invention.

FIG. 18 illustrates a data table for input data and output data for an existing accounts request pop-up application, according to an embodiment of the present invention.

FIG. 19 illustrates a data table for required data to establish a new account system connection between the RSN and FSP computer servers, according to an embodiment of the present invention.

FIG. 20 illustrates data tables for input data and output data for a new account return application for data flow between the RSN and FSP computer servers, according to an embodiment of the present invention.

FIG. 21 illustrates data tables for input data and output data for a create distribution request application for data flow between the RSP and RSN computer servers, according to an embodiment of the present invention.

FIG. 22 illustrates data tables for input data and output data for a distribution status request application for data flow between the RSP and RSN computer servers, according to an embodiment of the present invention.

### DETAILED DESCRIPTION

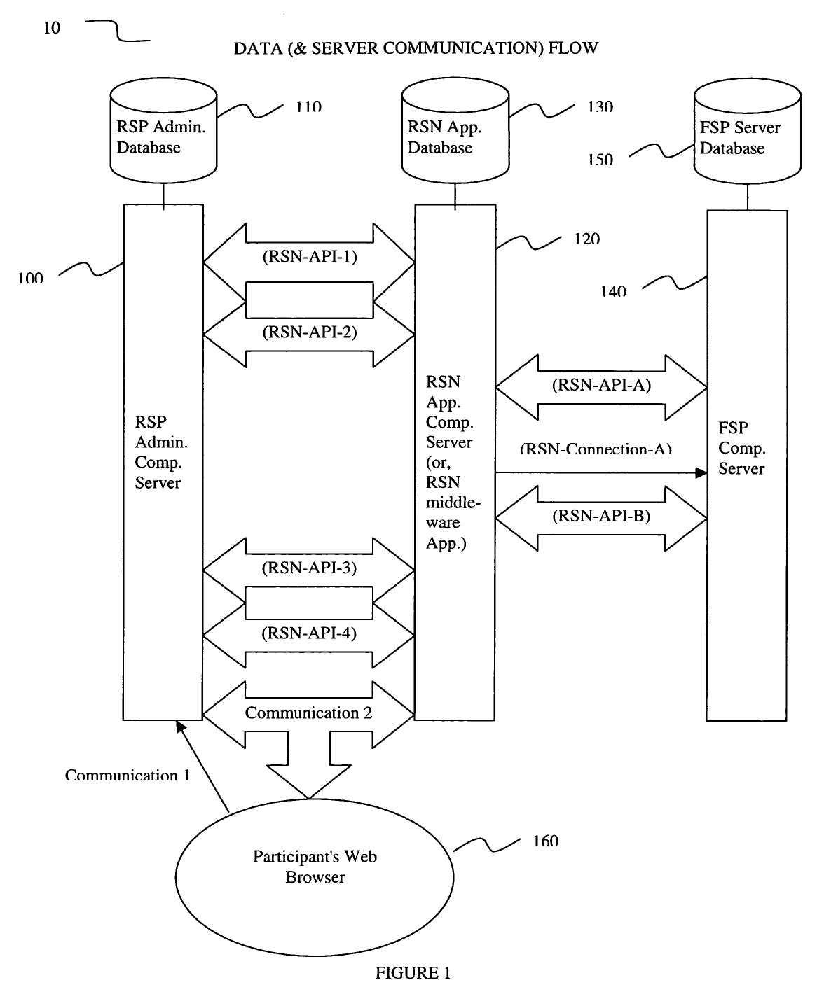

FIGS. 1 through 22 illustrate an exemplary system and method for data and server communication between savings plan administrators and financial service providers through use of the rollover solutions network electronic middleware interface. The electronic middleware interface establishes communication interfaces as between the computer servers allowing for seamless data transfer and provision of financial account openings and fund transfers. The middleware application is based upon ASP technology, and leverages Model-View-Control (MVC) application methodologies and Create-Retrieve-Update-Delete (CRUD) database methodologies. In its preferred embodiment, the middleware technology platform is built on the: Windows 2003 operating system; SQL Server 2000 SP3, Microsoft IIS version 4.0 (or later); Microsoft XML Parser SDK 4.0; ASP, ASP.NET; and Active PDF Toolkit version 3.5.2 service pack 5A (or later).

In terms of installation, the Rollover Solutions Network (RSN) middleware application is installed and hosted on the RSN application computer server and requires the creation of a SQL database, SQL Stored Procedures, and SQL Trigger files. The setup is controlled by the installer and is completed using a BuildDB command that creates all of the required elements sequentially on the new SQL server. After the database is in place, the installer installs all of the required web components within the physical space defined by IIS for the existing retirement savings plan administrator web site. The installer then creates all of the necessary directories, web files, image files, and configures any additional IIS settings as the final component of the installation process. Thus, the RSN middleware application is fully integrated into the retirement savings plan administrator computer server and web site.

Referring now to FIG. 1, a system for data and server communication flow 10 which functions as an electronic middleware interface is shown. The system 10 consists of a retirement savings plan (RSP) administrator computer server 100, an RSN application computer server 120, and a financial service provider (FSP) computer server 140. The RSN middleware application creates a connection from the RSP's computer servers to account opening application systems at the selected FSP. Connection between the servers is accomplished via Hyper-Text Transfer Protocol Secure (HTTPS) and SSL3 protocol and encryption, and for every transaction and/or transfer of data there between authentication utilizes both server and client certificates. In addition, within the system 10 each of the computer servers has its respective database 110, 130 and 150. A participant's web browser 160 is utilized to connect to and gain access to the RSP computer server 100 and the RSN computer server 120.

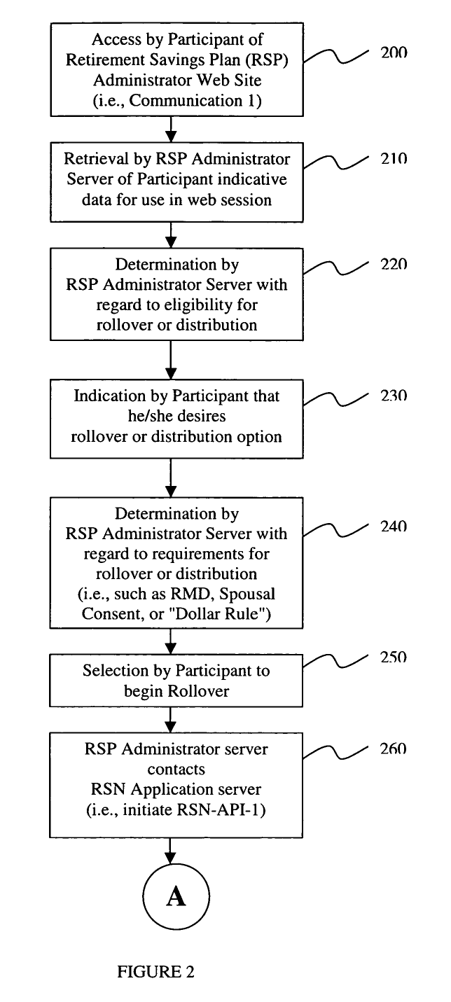

Referring now to FIG. 2, at step 200 a participant in a retirement savings plan utilizes his/her web browser 160 to access (log onto) the RSP administrator website server 100 in Communication 1. Upon access of the administrator website server by the participant, in step 210 the RSP administrator server retrieves from the RSP administrator database 110 the participants indicative data for use in the web session. The participant's indicative data includes plan information and account balances, among other participant identifying information.

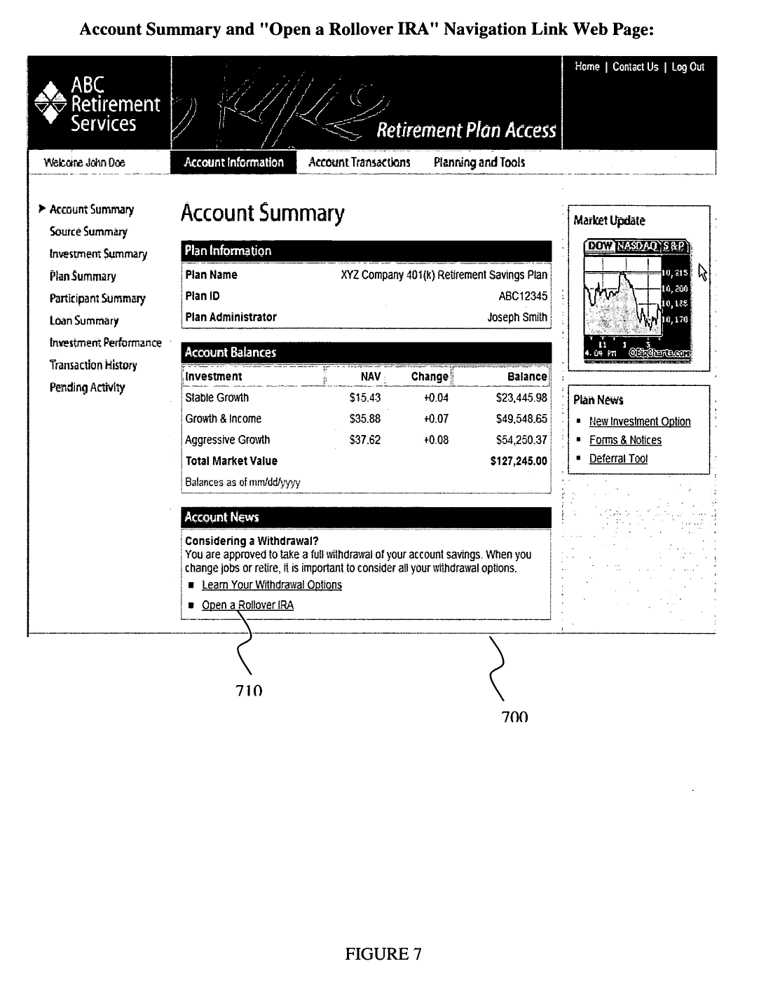

In step 220 the RSP administrator server utilizes the participant indicative data to make a determination as to the participants eligibility for either rollover and/or distribution of the participant's financial funds within the account. Assuming such rollover/distribution is permitted, and referring now to FIG. 7, an example of a web page 700 containing the participant's plan information and account balances is shown as it can be presented to the participant in the web session. In addition, web page 700 can contain a rollover and/or distribution navigation link 710 for the financial retirement plan participant. The navigation link 710 allows the participant to indicate that he/she does in fact desire to open a rollover IRA and begin the process of doing so by clicking on the navigation link.

Referring again to FIG. 2, at step 230 the participant clicks on the rollover/distribution navigation link indicating that he/she desires to begin the rollover option.

The participant having indicated a desire to start the rollover option, in step 240 the RSP administrator server makes the determination whether there are any mandatory requirements for the rollover option to proceed. For instance, such mandatory requirements may include: a required mandatory distribution (RMD) if a participant is of an age that such will be required; whether spousal consent for a rollover/distribution is required; or whether the participant account balance meets a minimum rollover threshold amount.

With regard to the RMD, if the participant is of age for an RMD, a notice will be displayed for the participant notifying them that as part of the process to rollover their assets to a FSP, the RMD will be deducted from the rollover eligible assets and sent to their address of record.

With regard to spousal consent, if spousal consent is required and not on file for the participant requesting the rollover, a notice will be displayed for the participant notifying them that a spousal consent form needs to be completed and on file before the rollover process can continue. The participant will not be able to proceed further until this condition is fulfilled.

With regard to the last determination, such “dollar rule” is a determination of whether there is a minimum dollar amount to initiation a rollover transaction set by participating financial service providers as to the amount eligible to open an account. In other words, if there is a minimum dollar amount to initiate a rollover transaction set by the RSP, any accounts falling below the minimum requirement will not be able to proceed. Further, if the RSP minimum dollar amount is less than that set by the FSP, the FSP threshold to initiate a rollover will supersede that set by the RSP.

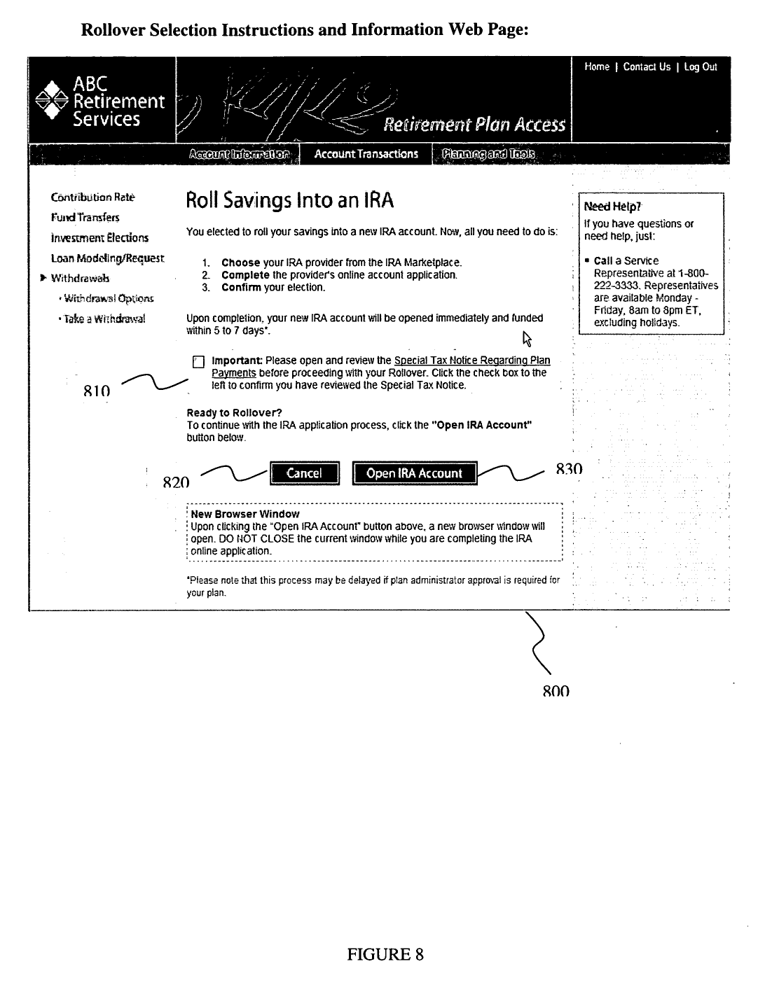

If the RMD, spousal consent and rollover threshold conditions do not apply, and referring now to FIG. 8, an example of a web page 800 which can be presented to the participant by the RSP administrator server is shown. Having made such determinations, instructions as to the rollover series of events and other information is now provided. In addition, a “special tax” notice 810 can be provided as needed. If provided, the participant will need to review the notice and check the verification box. Lastly, web page 800 contains an option provided to the participant to cancel or begin the rollover by clicking on navigation links 820 or 830 as the case may be.

Referring now back to FIG. 2, in step 250 the participant selects to begin the rollover by choosing the navigation link 830. In step 260, the participant having selected to begin the rollover, the RSP administrator server will then contact the RSN application server with a server to server call thereby initiating communication interface RSN-API-1. This call, as mentioned above, can be performed over a SSL-encrypted HTTPS connection. The input data parameters contained in the communication interface RSN-API-1 are: the participant's social security number, the participant's retirement account plan number, and a unique RSP administrator session identifier.

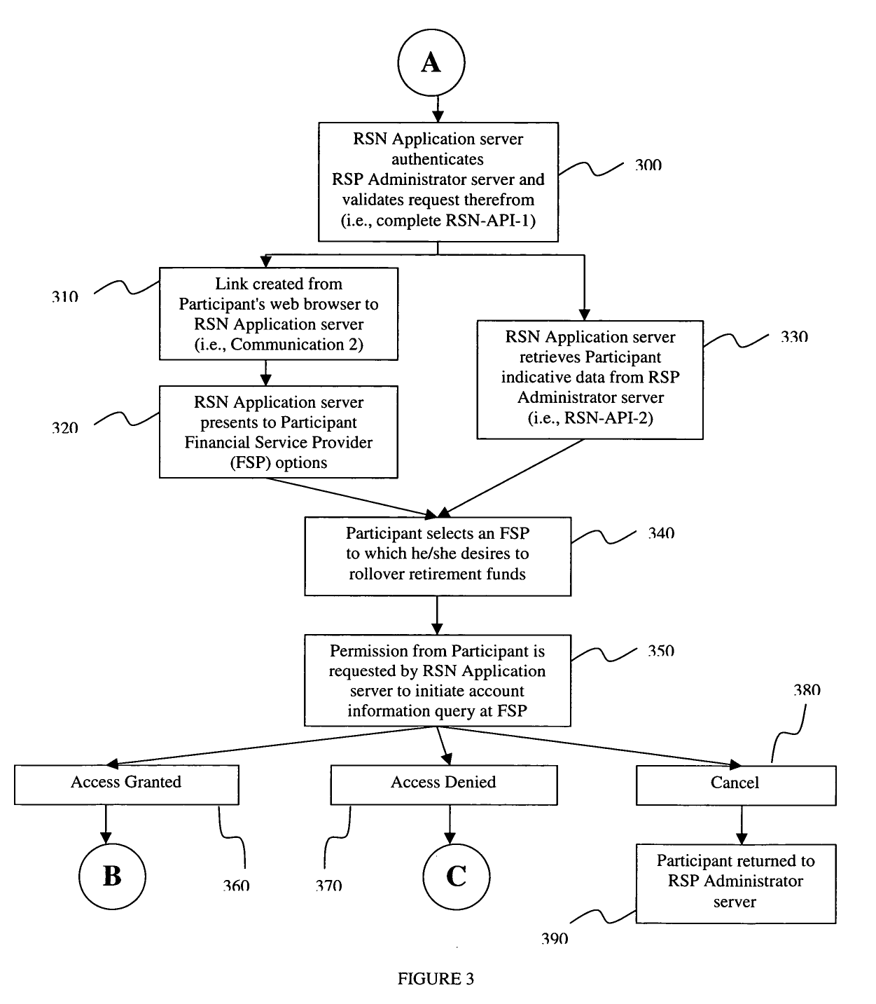

Referring now to FIG. 3, in step 300 the RSN application server receives the request and authenticates the RSP administrator server making the request by performing a look-up of that server's security certificate in the RSN application server data base 130. It is to be understood, of course, that such security certificate would have previously been registered with the RSN application server through use of an administrative application. Once the authentication is complete, the RSN application computer server 120 validates the input data, and generates a unique 38 character authentication token string, stores both the input data and the token string in the data base 130, and returns the token string in a communication to the RSP administrator computer server 100 by means of a server to server call thereby completing communication interface RSN-API-1.

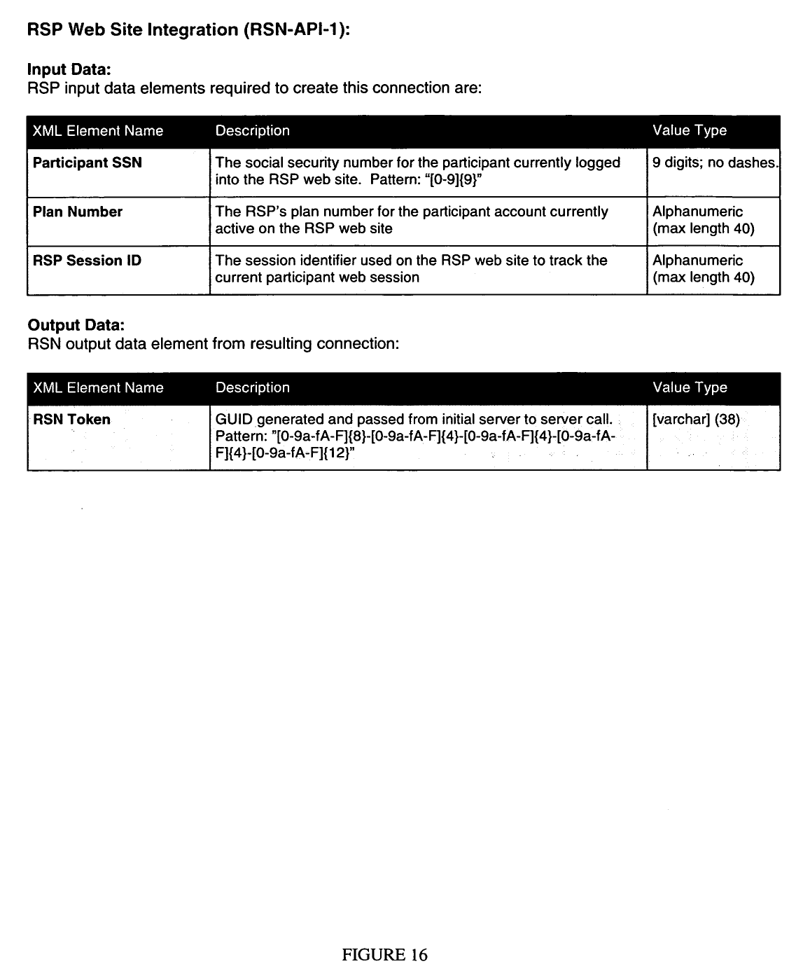

Referring now to FIG. 16, the input data and output data exchanged during the web site integration server-to-server communication interface RSN-API-1 is shown. The input data can include the participant's social security number, plan number and the session identifier used by the RSP administrator website to track the participant's web session. The output data can include the unique 38 character authentication token string. An example of an authentication token string generated and returned is:

Authentication Token String: [89072E78-9748-4D8D-A30A-81C1834276E3].

Referring now back to both FIGS. 1 and 3, having received a validation from the RSN application computer server 120 and the communication interface RSN-API-1 having now been established by the server to server calls, in step 310 the RSP administrator computer server 100 generates and sends instructions to the participant's web browser 160 to cause the browser 160 to open up a new pop-up window. These instructions cause the browser window 160 to perform an HTTP form post Communication 2 to the initial page of the RSN middleware application. As the RSN middleware application is fully integrated to the RSP administrator server and web site, it can be configured to launch from the distribution options page. The launch of the RSN middleware application requires a new browser window, Frame or iFrame upon the initialization of the above security methodology.

In addition, for additional security the form post Communication 2 includes as data the authentication token string. The RSN middleware application initial page identifies the authentication token passed during the form post. It uses this token to perform a lookup of the participant identification data that was stored during the server-to-server communication RSN-API-1 to the RSN application database 130. If the authentication token string passed by the form post is valid and can be matched within the RSN application database 130, the RSN middleware application launches within the new browser window. If the authentication string cannot be matched, an authentication error screen is displayed in the pop-up window. In addition, an error screen may be displayed if: the authentication token does not exist; the authentication token cannot be found in the database lookup; the authentication token has been previously used for authentication; or the authentication token has timed out.

A link having been established between the participant's web browser, the RSP administrator server and the RSN application server via the RSN middleware application, in step 330 the RSN application server 120 retrieves the full participant indicative data, utilizing information retrieved from the look up performed as a result of the form post Communication 2, from the RSP administrator server 100 by means of communication interface RSN-API-2. This call, as mentioned above, can be performed over a SSL-encrypted HTTPS connection. Authentication can be performed by the RSP administrator server by analysis of the RSN application server certificate.

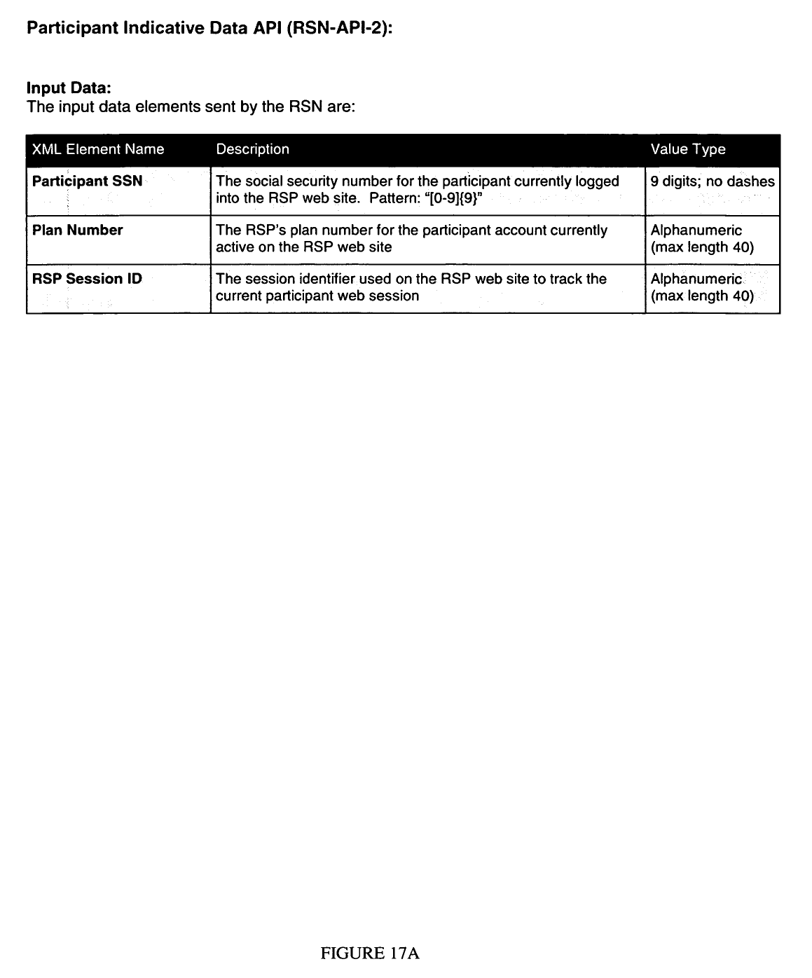

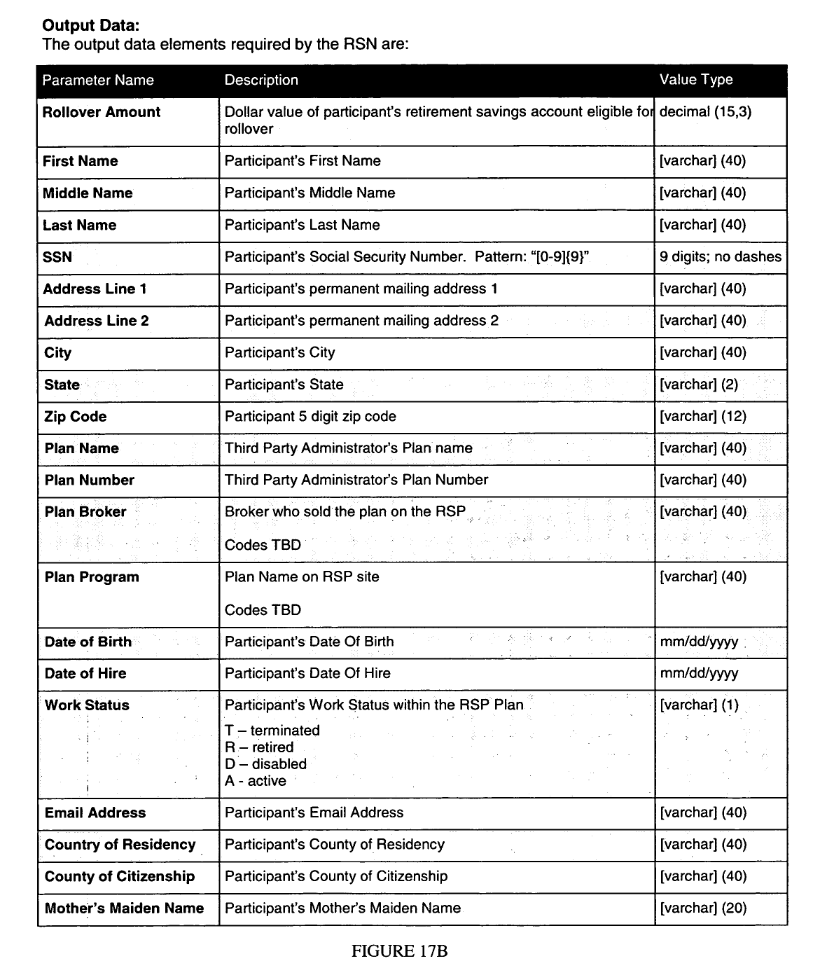

Referring now to FIGS. 17A and 17B, an example of the data exchanged as between the RSP administrator and RSN application computer servers via communication interface RSN-API-2 is shown. Upon retrieval of the full participant data, the RSN application server analyzes the data to ensure that all required fields have been populated. The data is then converted into a common XML input format and this data is sent to the RSN middleware application default.asp page via a form post. The default.asp page takes the XML input data and stores the data into the RSN application database.

Referring back to FIG. 3, in step 320 the RSN application server 120 presents to the participant a number of financial service provider (FSP) options. The RSN middleware application can be limited to only display to the participant those FSPs that are partnered with the RSP and RSN as destinations for participant rollovers.

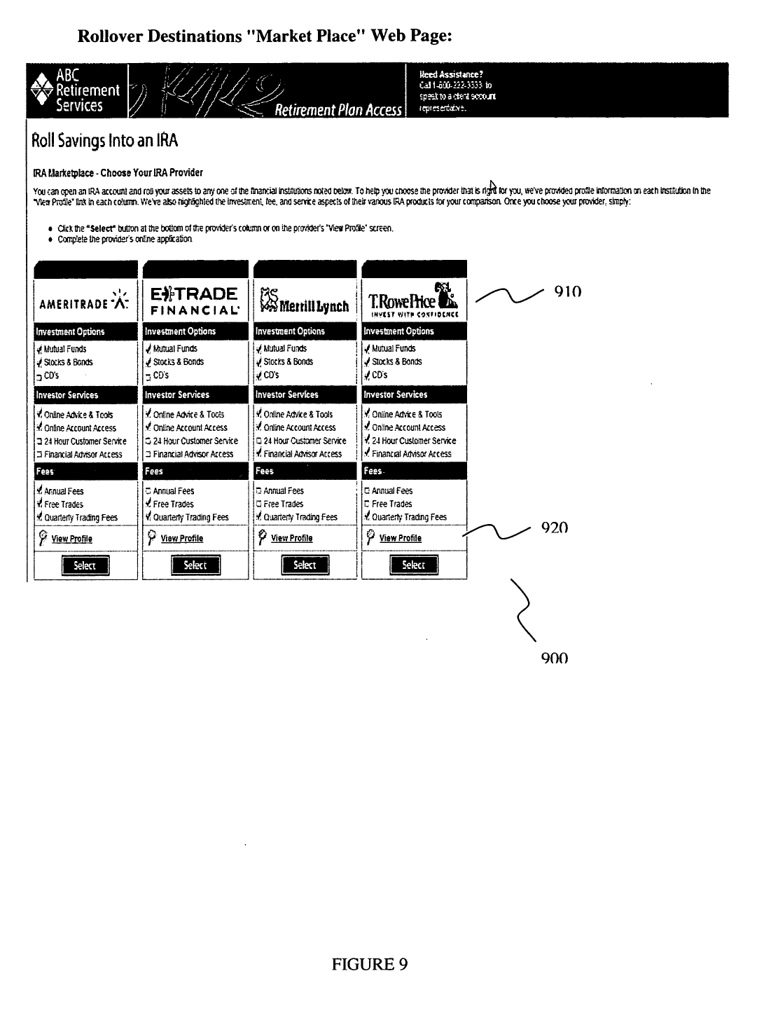

Referring now to FIG. 9, an example of a “Market Place” for potential destinations for rollover of the participant's financial funds is shown. The “Market Place” web page 900 shows those financial service providers which may serve as destinations for the participant rollovers. For example, such financial service providers may be: Ameritrade; E-Trade; Merrill Lynch; and T-Rowe Price, to name a few.

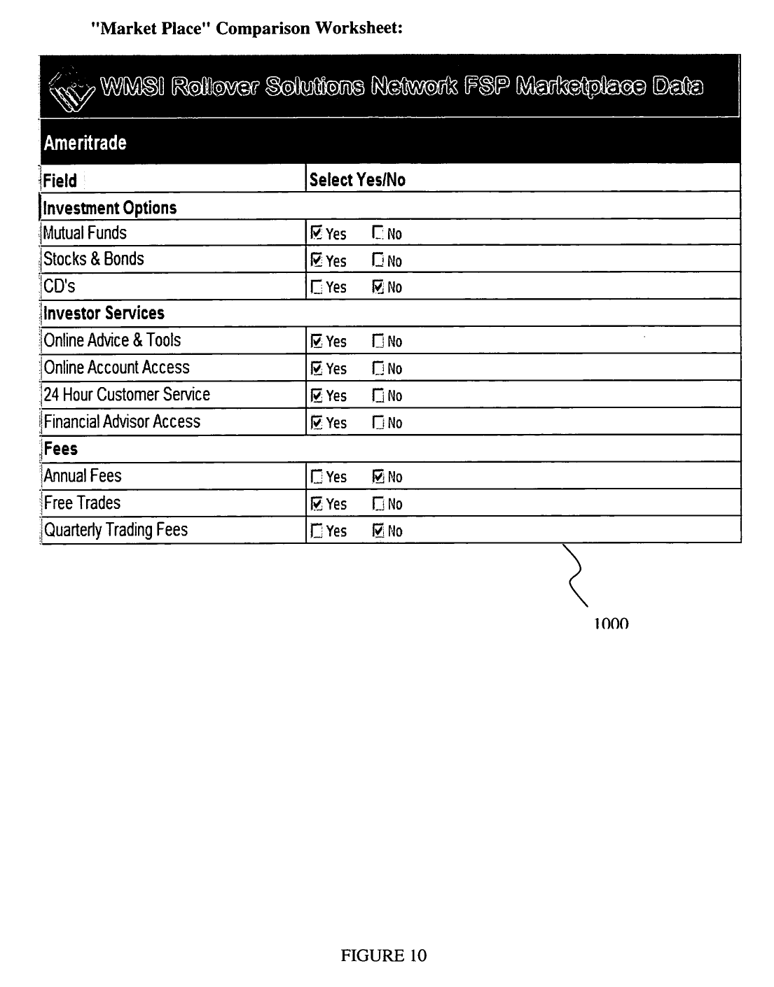

The participant is also presented with comparisons of the financial service provider's product attributes at a glance. The market place comparison content for each financial service provider is determined by information provided according to a check list entered by the financial service provider to the RSN application computer server. For instance, in FIG. 10, an example of a market place comparison work sheet 1000 is shown. Therein several data fields may be entered by the financial service provider.

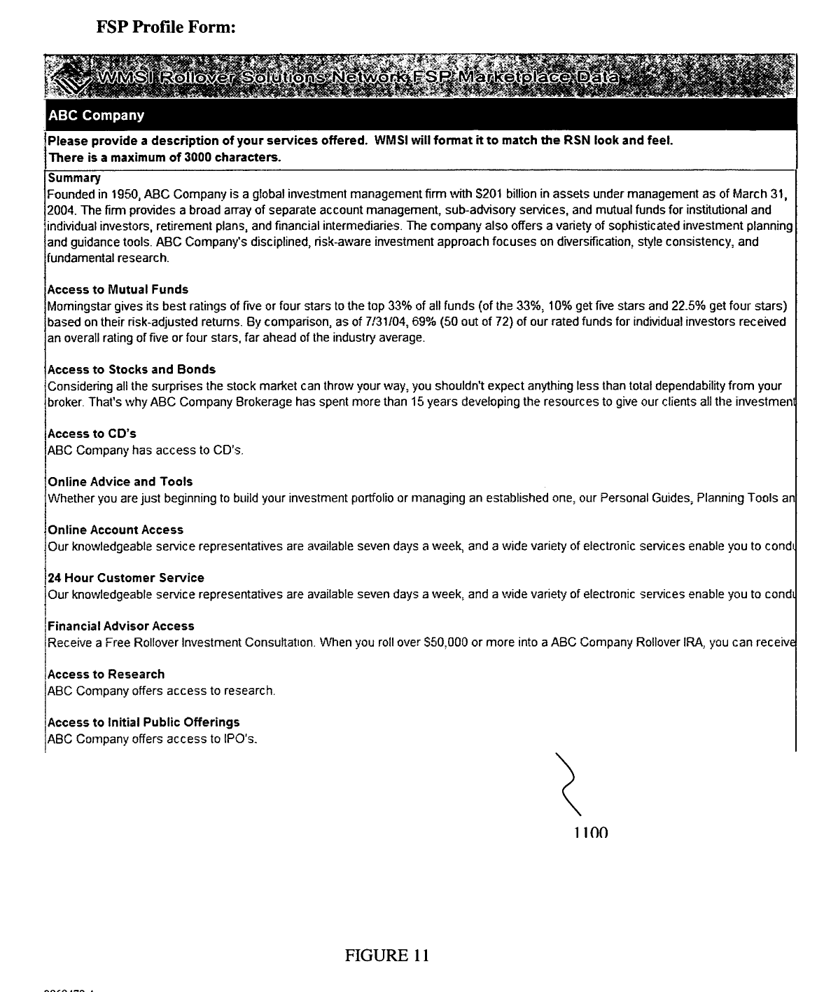

Referring back to FIG. 9, in addition there may be a view profile navigation link 920 available to display or print out a detailed description of each particular financial service providers profile. The content of the view profile navigation link 920 is determined by information provided by the financial service provider according to a profile entered by the financial service provider to the RSN application server. For example, in FIG. 11 an example of the financial service provider profile 1100 is shown. Therein a description of the services offered by the financial service provider may be entered.

Referring back to FIG. 3, in step 340 the participant will select a financial service provider to which he/she desires to rollover the retirement funds by utilizing the appropriate FSP select button.

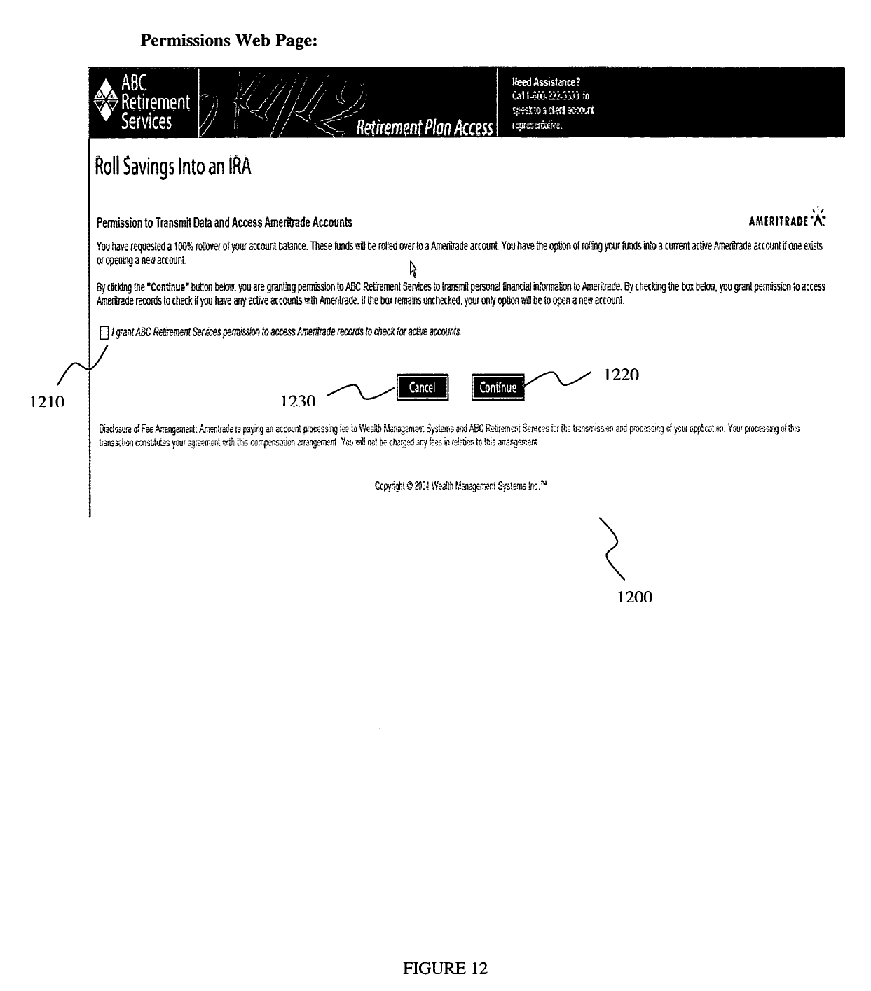

An indication of a choice having been made by the participant selecting an FSP to which to rollover his or her account, in step 350 the RSN middleware application will request permission from the participant to grant consent to transmit data to the FSP computer server 140 and allow for access of existing account information at the FSP server database 150. Such request is accomplished by displaying to the participant a permissions web page. For example, in FIG. 12, a permissions web page 1200 displayed to the participant is shown. Within this web page, block 1210 is utilized to request permission to access the participant's records at the financial service provider to check for active accounts. Such permission is granted by the participant by clicking on the block. In addition, buttons 1220 and 1230 are utilized to request in essence permission to transmit data to the FSP computer server by an indication of either continuing or canceling. The participant indicates a grant of permission for such transmission by clicking the continue button 1220, and indicates no grant of permission for such transmission by clicking the cancel button 1230.

Referring back to FIG. 3, should the participant decide to both allow for access of existing account information at the FSP server database and grant consent to transmit data to the FSP computer server, in step 360 the participant clicks block 1210 and then clicks continue button 1220. Alternatively, should the participant decide to deny the RSN application computer server 120 access to the participant's account information at the financial service provider computer server 140 but decide to continue with the rollover application process, in step 370 the participant does not click the block 1210 but only clicks the continue button 1220.

Also alternatively, in step 380, the participant may elect to cancel the rollover procedure by clicking the cancel button 1230. In the instance where the participant elects to cancel the process by denying permission to transmit their data electronically, they are provided an Alert Dialogue Box warning them that denying permission will cancel the transaction and return them to the RSP web site. This is also the case where even though block 1210 has been clicked, the participant has denied transmission permission by clicking the cancel button 1220. In such cases, the RSN middleware application will be canceled, the browser window closes, and the participant is returned to the RSP administrator web site. Thus in step 390 the participant is returned to the RSP administrator server 100 and the RSN-API-1 interface terminates.

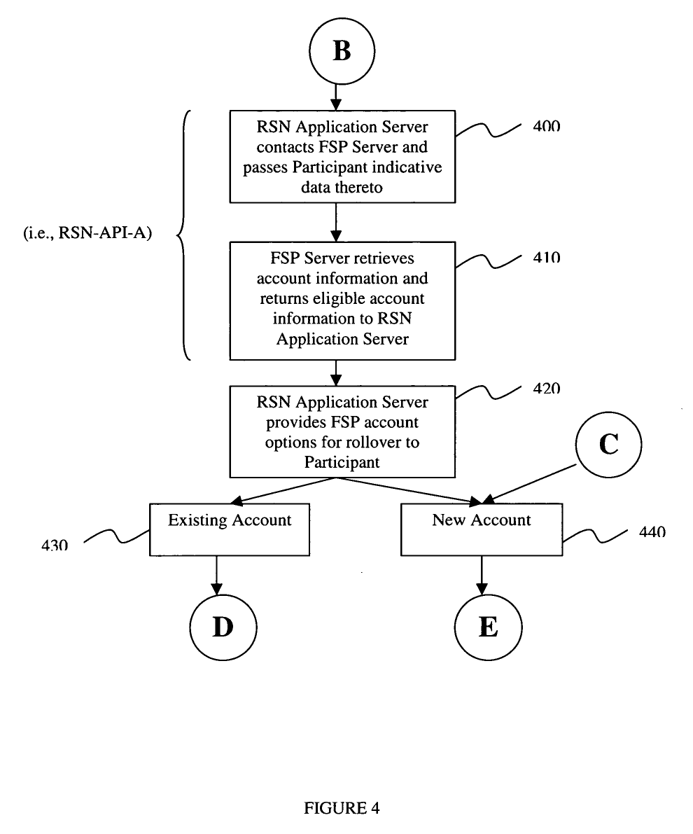

Referring now to FIG. 4, in the instance where the participant has elected to grant access and to continue, a form post passes the data to the RSN application server 120. The RSN application server notes the permission and in step 400 initiates contact with the selected financial service provider computer server 140 and, via data and server communication interface RSN-API-A, passes participant indicative data thereto. This communication, as mentioned above, can be performed over a SSL-encrypted HTTPS connection, and authentication is token based. In step 410 the FSP server 140 retrieves account information from the FSP server data base 150 and returns the eligible account information to the RSN application server 140. All existing account data is displayed to the participant, however, the full listing is not stored in the RSN application server database 130, rather only the existing account that is selected by the participant is stored.

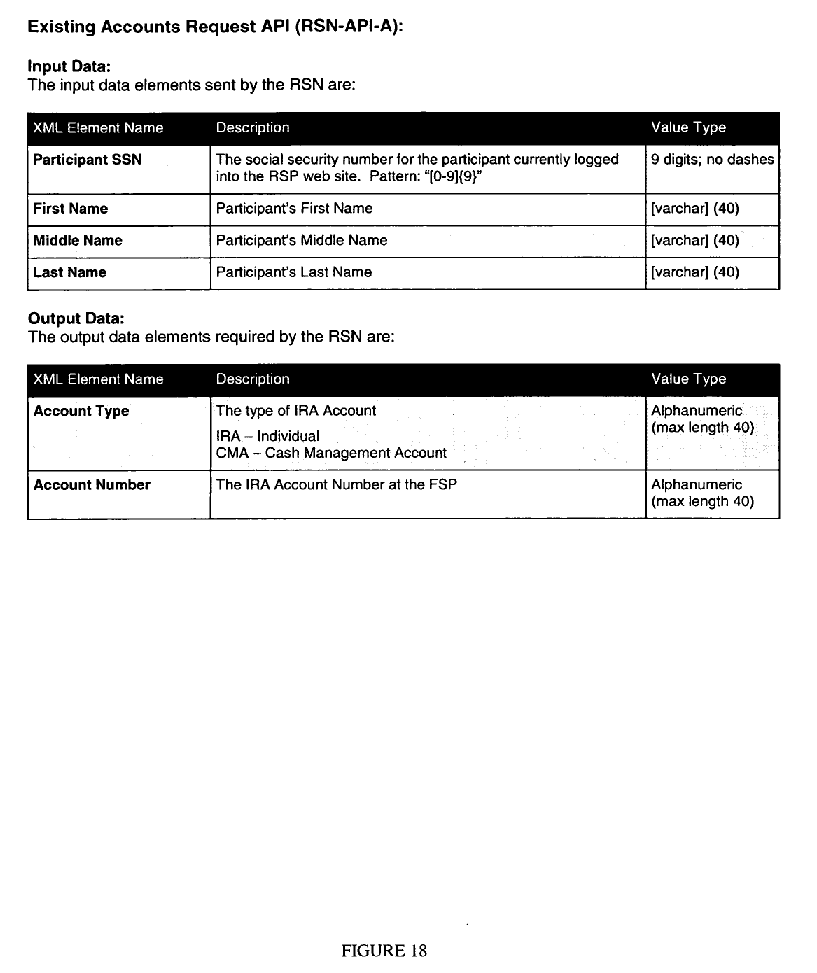

Referring now to FIG. 18, input data and output data exchanged between the FSP server 140 and the RSN application server 120 in the existing accounts request communication interface RSN-API-A is shown. The input data sent by the RSN application server consists of such as the participant's social security number and first middle and last names. The output data required by the RSN application server are such as the account type and account number.

Referring back to FIG. 4, having the participant's account data as provided by the financial service provider computer server, in step 420 the RSN application server provides the account options for rollover to the participant. As shown by step 430, if the participant chooses to transfer their funds to an existing account, the RSN middleware application takes them directly to the confirmation screen. Alternatively, as shown by step 440, the participant is always given the option to open a new account. Further, if as discussed above, the participant had elected to deny access to the RSN application computer server 120 to the participant's account information at the financial service provider computer server 140, but allow their data to be transmitted electronically, then the participant is directed immediately to step 440 wherein the participant will be directed to open a new account.

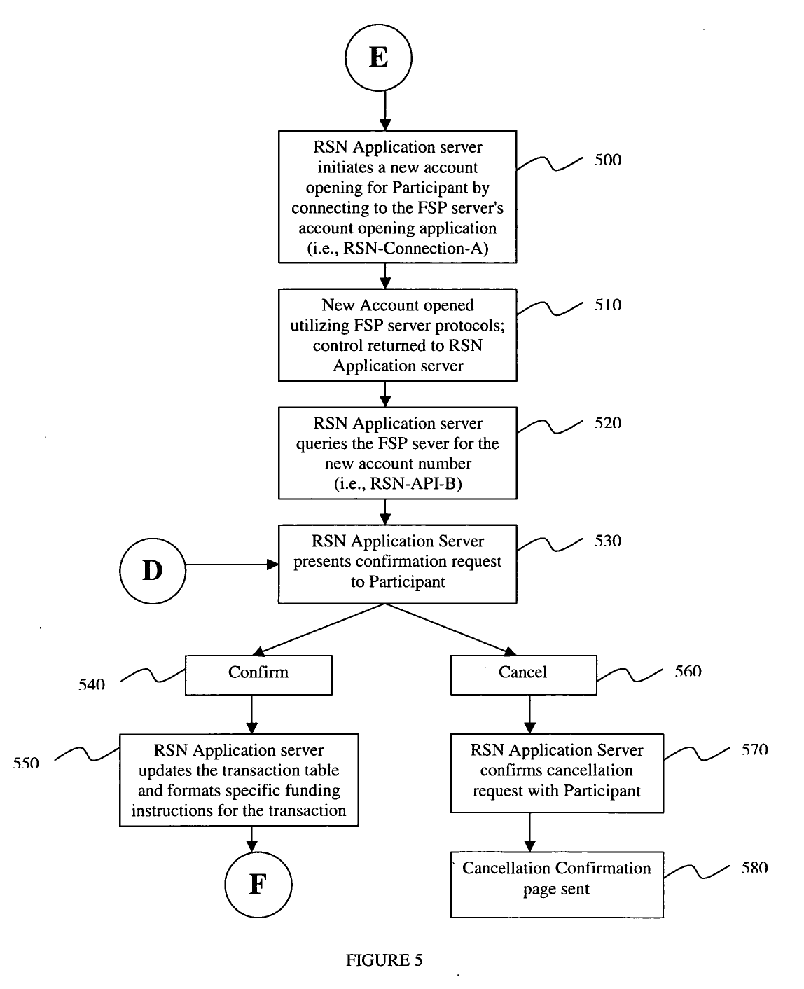

Referring now to FIG. 5, in step 500 the RSN application server 120 initiates a new account opening for participant by connecting to the FSP computer server 140 account opening application. The RSN middleware application will display on the web browser a page that contains an iframe. The iframe controls the full set of real estate on the browser screen. The account opening application is executed in the context of the iframe. Such occurs through utilization of RSN-connection-A interface. This connection interface gathers from the database all the data that the FSP account opening application requires for start up from the RSN middleware application environment. Included in the data are the RSN application server “return URL” and “cancel URL” that are used by the FSP account opening application to transition back to the RSN middleware application once the new account opening process is completed.

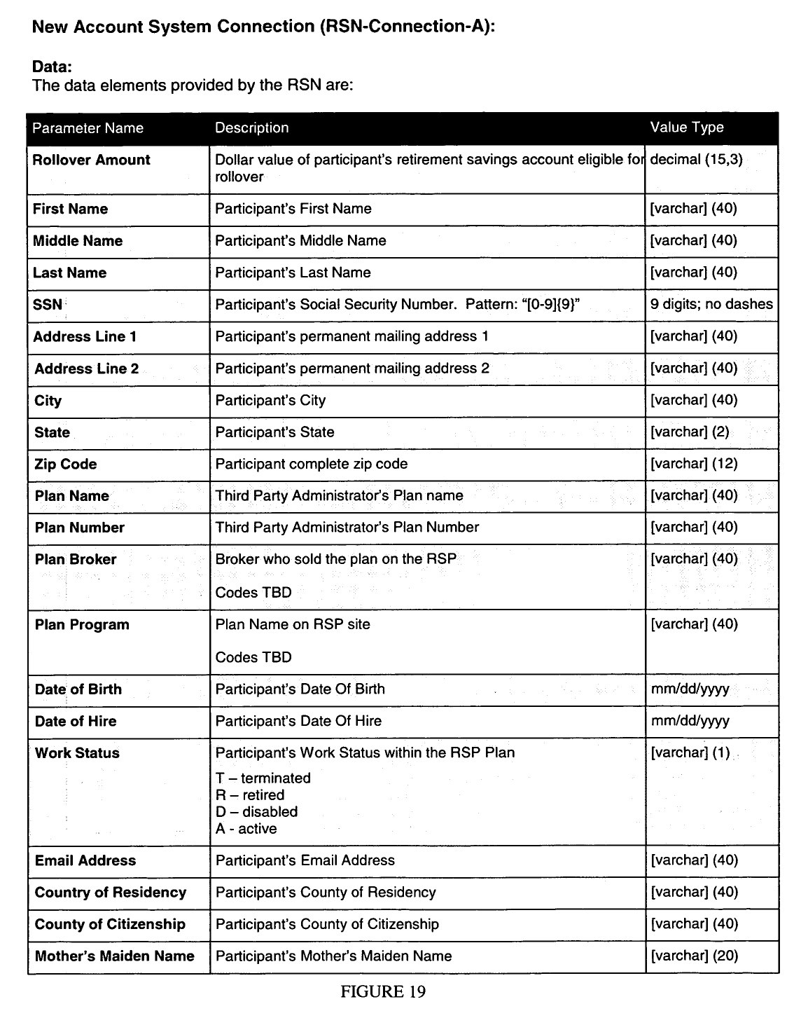

Referring now to FIG. 19, the data elements gathered from the database by the new account system connection interface RSN-connection-A and provided by the RSN application computer server 120 to the FSP computer server 140 is shown. Such data elements are for example the rollover amount, the first, middle, and last names of the participant, the participant's social security number, etc. This data is used by the FSP's new account opening system to pre-populate required fields.

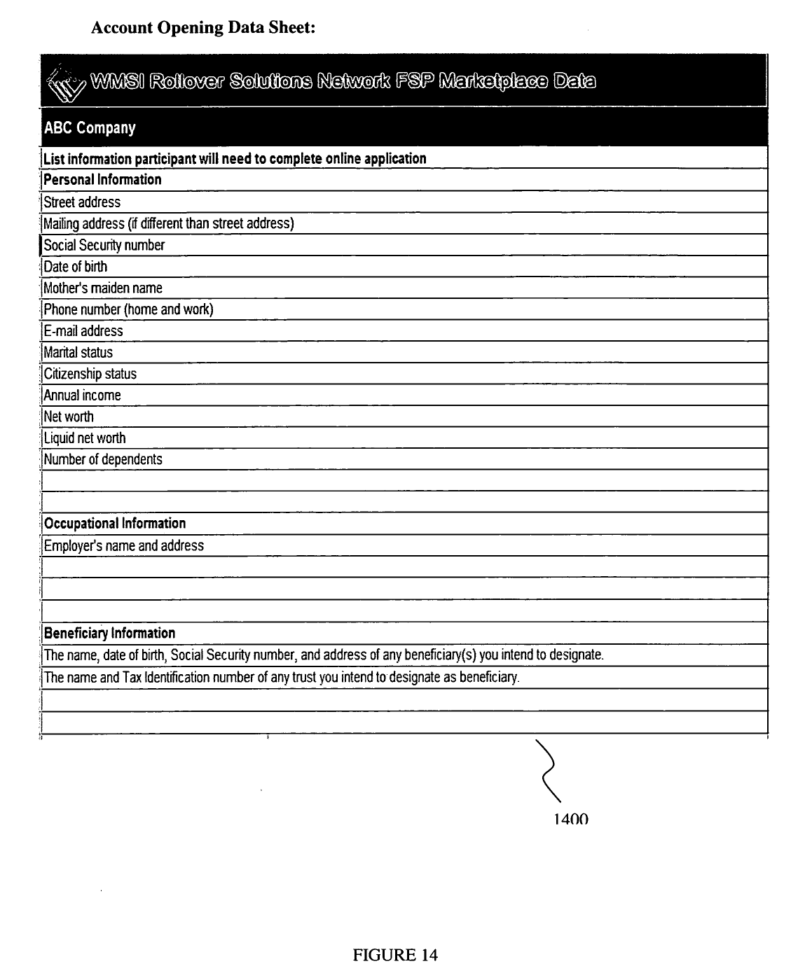

Referring back to FIG. 5, utilizing the data provided through the connection interface, in step 510 a new account is opened utilizing the FSP server protocol. The new account opening program is executed, which program gathers from the FSP server data base 150 all of the data that the FSP account opening applications require for startup from the RSN application server 120 environment. The initial new account opening page will display the required data to be provided by the participant. An new account opening data sheet 1400, shown in FIG. 14, will display the required data to be provided by the participant. In other words, required information that is not part of the participant indicative data transfer to the FSP computer server 140 by the interface RSN-API-A will be provided manually during the account opening process by the participant. For instance such information has personal information, occupational information, and beneficiary information. The page content 1400 is determined by the FSP based on the work sheet.

Once the participant data is gathered, the RSN program encrypts the data and the encrypted data is sent over a secured connection to the first page of the FSP account opening application. The FSP program decrypts the data and uses it to populate the FSP account opening application. The account opening application then runs in the FSP computer server and is displayed in the browser iframe of a pop-up window.

When the RSN runs the FSP Account Opening Application inside of the iframe the FSP Account Opening Application is treated by the browser as being a “third-party” program. In order to prevent the browser from blocking the storage of third-party cookies (both persistent and non-persistent), the FSP must encode their P3P Response Header with a policy that overrides the default browser policy and allows the third party cookies to be stored from within the iframe.

Upon successful completion of the account opening process, also in step 510, the FSP account opening application invokes the “return URL” that was sent as a part of the initial form post. This causes control in the application to return to the RSN application server.

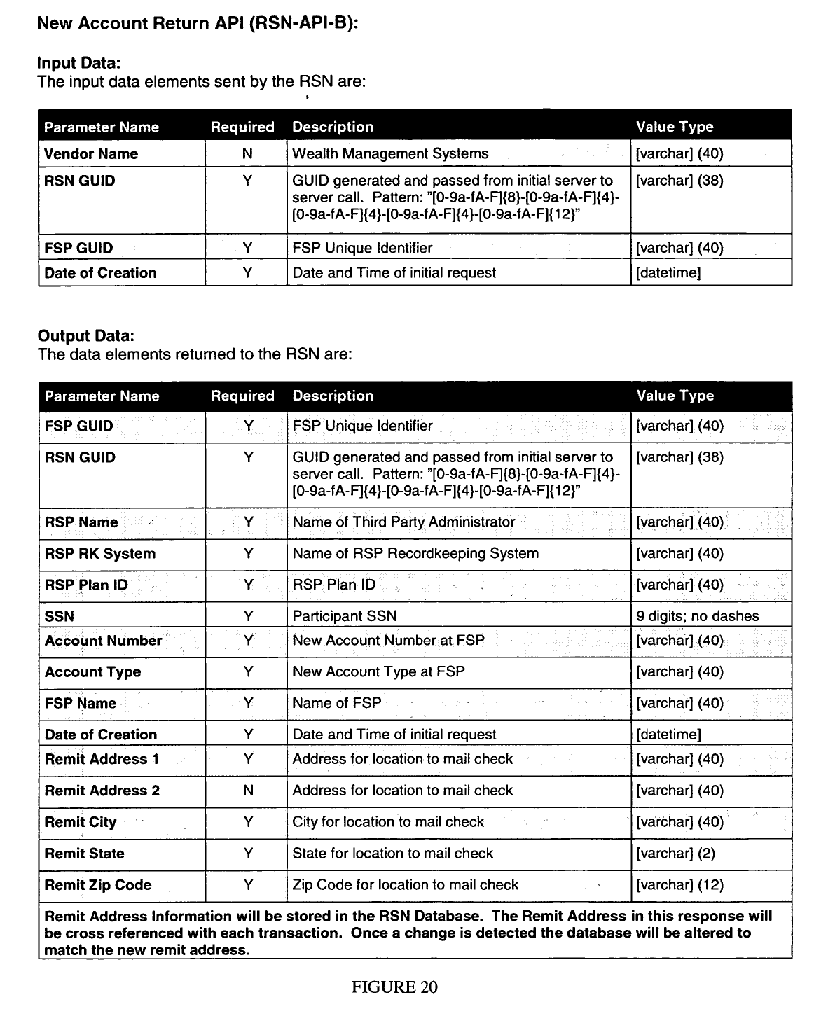

The RSN application computer server 120 notes that control has been returned to it and, in step 520, the RSN application server queries the FSP server for the new account number by initiating server-to-server communication interface RSN-API-B. The input and output data required by the new account return communication interface RSN-API-B is shown in FIG. 20.

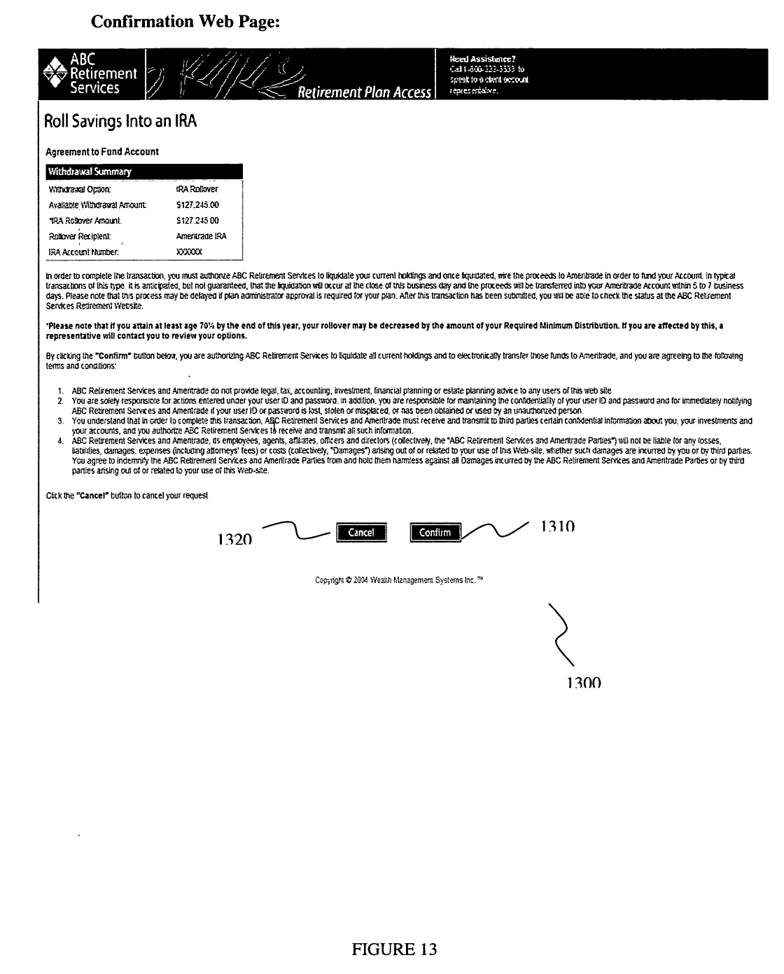

In step 530, either having gone through the steps for opening a new account at the FSP server or presenting to the participant the existing accounts, in step 530 the RSN application server presents a confirmation request to the participant. An example of a confirmation request web page is shown in FIG. 13. The confirmation screen web page 1300 presents the choice to the participant to confirm or cancel the scheduled transaction. In step 540 the participant may confirm the transaction by clicking the confirmation button 1310, or in step 560 may cancel the transaction by clicking the cancel button 1320.

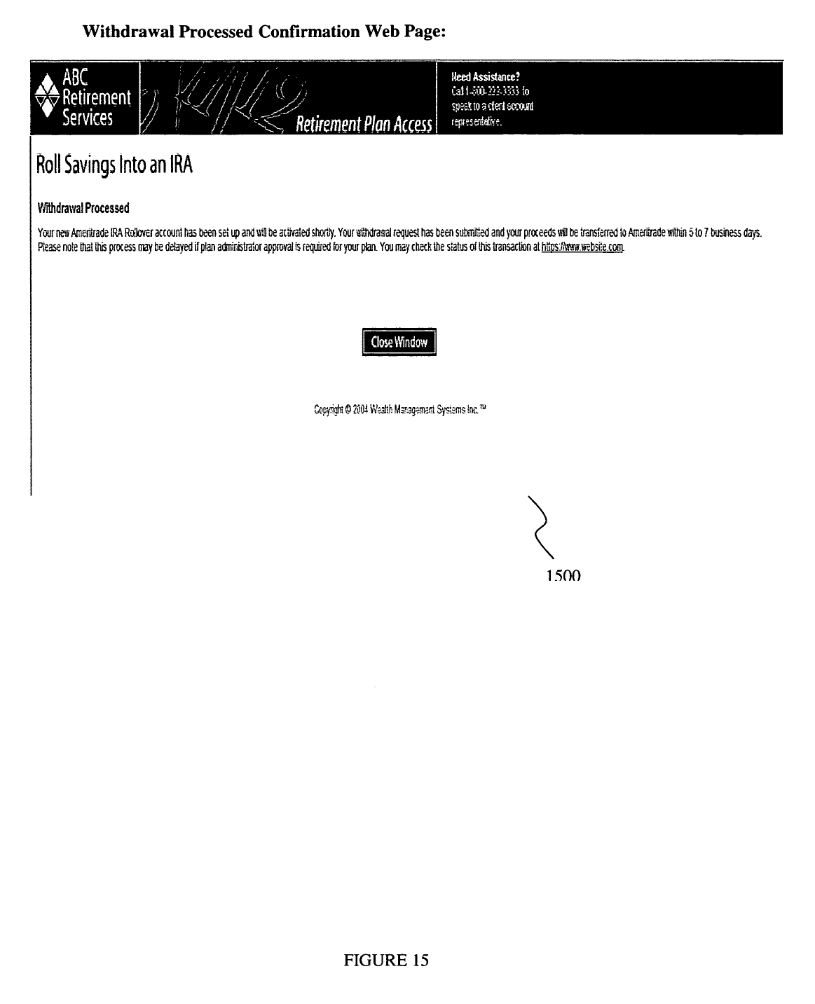

If a participant elects to confirm the rollover transaction, in step 550 the RSN application server 120 will update the transaction table residing on the RSN application data base 130 and format specific funding instructions for the transaction. A withdrawal confirmation notice is then sent to the participant. An example of a withdrawal confirmation web page is shown in FIG. 15. If instead the participant elects to cancel the transaction, in step 570 the RSN application server will confirm cancellation request with the participant in step 570. Should the participant elect to confirm the cancellation request, then in step 580 the participant is sent a page specifying that the request has been cancelled and allowing the participant to close the pop-up window.

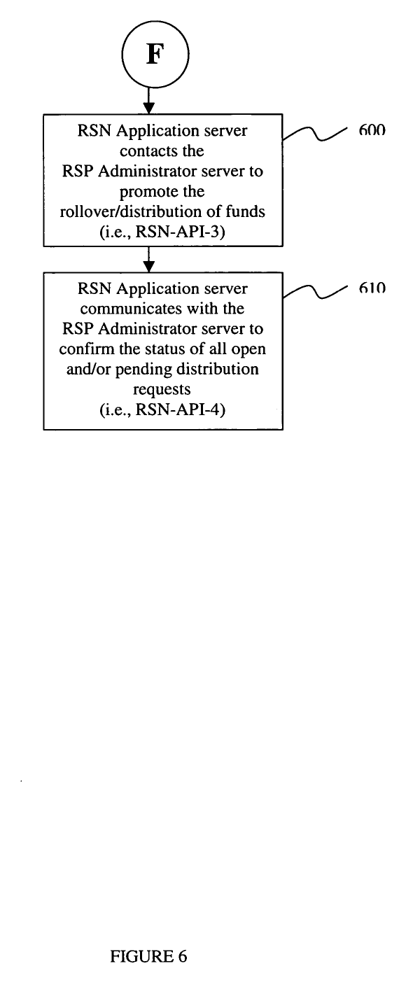

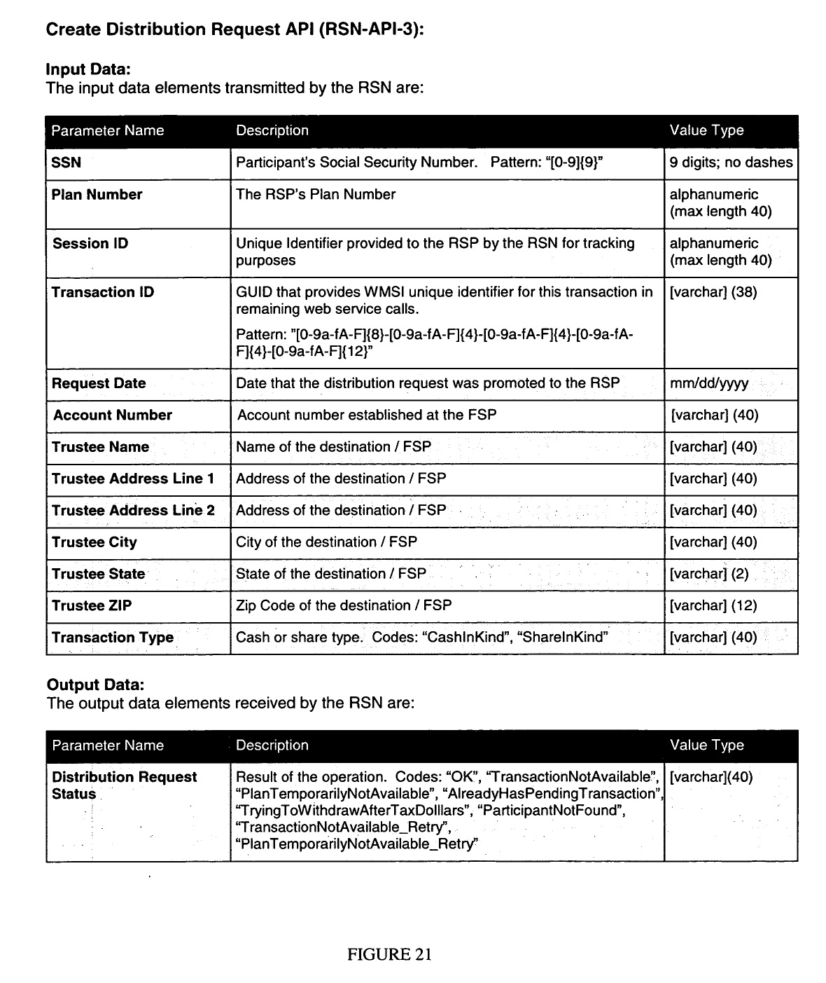

Referring now to FIG. 6, the RSN application server having formatted the specific funding instructions for the transaction, in step 600 will contact the RSP administrator server 100 to promote the rollover/distribution of the retirement fund. The RSN application server will promote such rollover of retirement funds utilizing data and server communication interface RSN-API-3. To create distribution request interface RSN-API-3 is shown in FIG. 21. The input data transmitted by the RSN server to the RSP administrator consist of the participant's social security number, the financial service provider's plan number, and a transaction ID, etc. In reply the output data sent by the RSP administrator to the RSN application are the distribution request status. The RSN application computer server 120 checks the data base 130, on a once per second basis for transactions that are ready to be transmitted to the RSP administrator to request a distribution. Transactions are considered to be ready for transmission when the following conditions are met: the participant has selected an existing account or has retunred from the FSP new account program via the return URL; and the participant has performed to submit on the final approval request page; and if the user has requested a new account number, the account number has been delivered and stored in the data base.

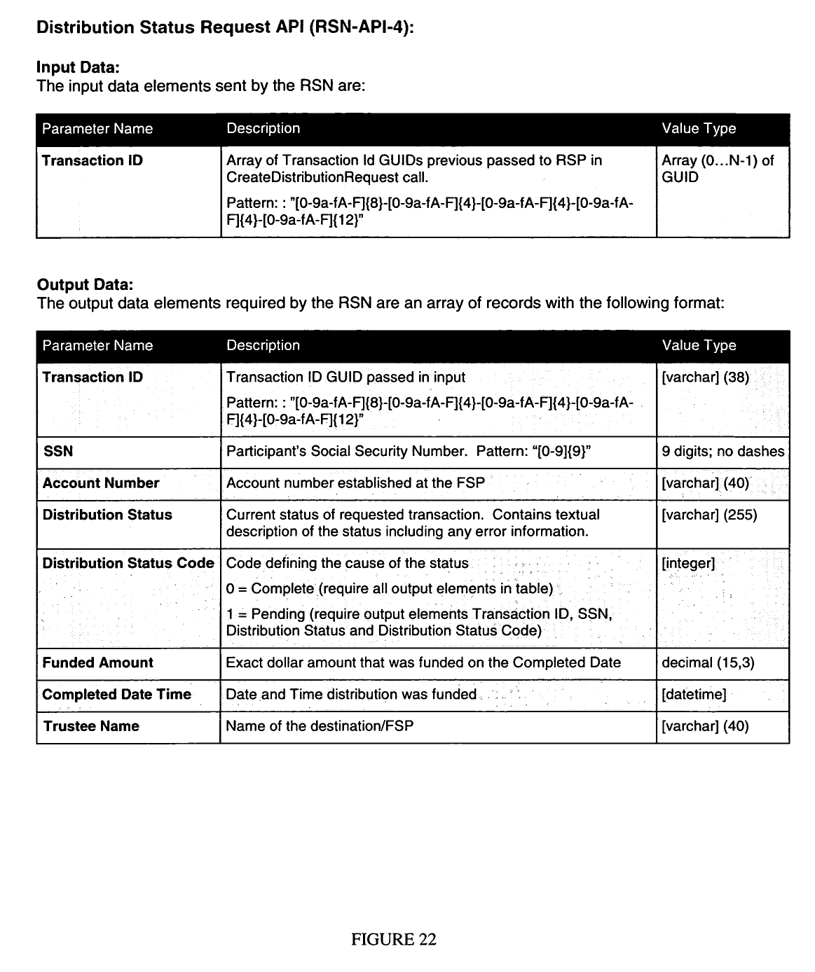

Having made contact with the retirement service provider administrator the RSN application server in step 610 will track the distributions. On an at least once per hour basis the RSN application computer server 120 will check the data base 130 for transactions that have been submitted to the RSP administrator 100 for distribution of funds which are pending. For each qualified transaction record that has been found in the data base, the RSN application computer server 120 will communicate with the RSP administrator server 100 to confirm the status of all the open and/or pending distribution requests. Such distribution status request communication utilizes RSN-API-4 interface. The required input data and output data for the RSN-API-4 interface is shown in FIG. 22. The RSP administrator 100 returns a status code to the RSN application server to confirm the status of the transaction as repeat or pending. If the status has been returned as completed the RSN application computer server 120 it will update the transaction record in the RSN application data base 130 to show that it is now in a completed state.

In the foregoing description, the apparatus and method of the present invention have been described with reference to specific examples. It is to be understood and expected that variations in the principles of the apparatus and method herein disclosed may be made by one skilled in the art and it is intended that such modifications, changes, and substitutions are to be included within the scope of the present invention as set forth in the appended claims. The specification and drawings are accordingly to be regarded in an illustrative rather than in a restrictive sense.

What is claimed is:

1. A method utilizing a rollover middleware application for interfacing between a retirement savings plan administrator server and a financial service provider server to automate account opening and distribution processes for retirement savings, the method comprising the steps of:
integrating the savings plan administrator server with a rollover network system server via a “web site integration” server-to-server communication interface;
retrieving participant indicative data from the savings plan administrator server and storing the participant indicative data on the rollover network system server via a “participant indicative data” server-to-server communication interface;
querying the financial service provider server for existing account information via an “existing accounts request” server-to-server communication interface; and
promoting the distribution of retirement savings to one of an existing account and a new account via a “create distribution request” server-to-server communication interface.

2. The method according to claim 1, further comprising the step of:
initiating the rollover middleware application.

3. The method according to claim 1, further comprising the step of:
providing different options of financial service providers to which the retirement savings may be distributed.

4. The method according to claim 1, further comprising the step of:
requesting permission to initiate an existing account information query at a financial service provider.

5. The method according to claim 1, further comprising the step of:
providing different options of accounts to which retirement savings may be distributed.

6. The method according to claim 1, further comprising the step of:
initiating a new account opening at a financial service provider via a “new account” system connection.

7. The method according to claim 6, further comprising the step of:
retrieving new account information from the financial service provider server via a “new account return” server-to-server communication interface.

8. The method according to claim 1, further comprising the steps of:
updating a transaction table with one of existing account information and new account information; and
utilizing the transaction table to format distribution instructions.

9. The method according to claim 1, further comprising the step of:
providing a mechanism by which to cancel the account opening and distribution processes.

10. The method according to claim 1, further comprising the step of:
confirming the status of the distribution of retirement savings via a “distribution status request” server-to-server communication interface.

11. The method according to claim 1, wherein the rollover middleware application resides on one of the savings plan administrator server and the rollover system network server.

12. The method according to claim 1, further comprising the step of:
creating a link from a participants web browser to the rollover network system server.

13. The method according to claim 12, wherein the link is established by a form post instruction and takes the form of a pop-up window.

14. A method for facilitating a rollover of retirement savings from a retirement savings plan administrator to a financial service provider via a web session on the Internet, the method comprising the steps of:
retrieving participant indicative data for the retirement savings for use in the web session;
providing at least one option for selection of the financial service provider;
querying the financial service provider for account information utilizing the participant indicative data;
providing for selection of an account at the financial service provider; and
initiating the rollover of the retirement savings from an account at the retirement savings plan administrator to the selected account at the financial service provider.

15. The method according to claim 14, further comprising the step of:
determining eligibility of the retirement savings for rollover based upon the retrieved participant indicative data.

16. The method according to claim 14, further comprising the step of:
determining requirements for rollover of the retirement savings.

17. The method according to claim 16, wherein the requirements for rollover of the retirement savings comprise at least one of:
a required mandatory distribution;
a required spousal consent; and
a “dollar rule”.

18. The method according to claim 14, wherein the selection of an account at the financial service provider is that of one of an existing account or a new account.

19. The method according to claim 18, wherein if the selection is for the new account, then the method further comprises the step of:
initiating a new account opening protocol at the financial service provider.

20. The method according to claim 14, further comprising the step of:
confirming the status of the rollover of the retirement savings from an account at the retirement savings plan administrator to the selected account at the financial service provider.

21. The method according to claim 14, further comprising the step of:
providing an option for cancellation of the web session for rollover of the retirement savings.

22. An apparatus to facilitate data flow for automation of the rollover process of retirement savings, the apparatus comprising:
a retirement savings plan administrator computer server;
a financial service provider computer server; and
a communication medium linking the retirement savings plan administrator computer server to the financial service provider computer server,
wherein a rollover network system middleware application controls server-to-server communication interfaces over the communication medium to:
integrate the rollover network system middleware application with the retirement savings plan administrator computer server;
retrieve participant indicative data from the retirement savings plan administrator computer server;
query the financial service provider computer server for existing account information; and
promote the rollover of the retirement savings from a retirement savings plan administrator to a financial service provider.

23. The apparatus according to claim 22, further comprising:
a rollover network application computer server connected to the communication medium.

24. The apparatus according to claim 22, wherein the rollover network system middleware application resides on one of the retirement savings plan administrator computer server and a rollover network application computer server.

25. The apparatus according to claim 22, further comprising:
a retirement savings plan administrator computer server database connected to the retirement savings plan administrator computer server.

26. the apparatus according to claim 22, further comprising:
a financial service provider computer server database connected to the financial service provider computer server.

27. The apparatus according to claim 23, further comprising:
a rollover network application computer server database connected to the rollover network application computer server.

28. The apparatus according to claim 22, wherein participant indicative data is stored on at least one of:
a retirement savings plan administrator computer server database connected to the retirement savings plan administrator computer server;
a financial service provider computer server database connected to the financial service provider computer server; and
a rollover network application computer server database connected to the rollover network application computer server.

29. The apparatus according to claim 22, wherein the rollover network system middleware application controls web page flow to allow a web browser to engage in the rollover process of retirement savings.
